(19) United States
(12) Patent Application Publication
(10) Pub. No.: US 2026/0367843 A1
(43) Pub. Date: Nov. 19, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: YUKIHIRO NARITA, Tokyo (JP)

(21) Appl. No.: 19/666,892

(22) Filed: May 4, 2026

(30) Foreign Application Priority Data
May 13, 2025 (JP) 2025-080629

(51) Int. Cl. G06F 3/12

(52) U.S. Cl. CPC G06F 3/1205; G06F 3/1258

(57) ABSTRACT

A non-transitory computer-readable storage medium stores an application program which causes an information processing apparatus, which is connected to a printing apparatus, to perform a control method, the application program cooperating with a standard driver which is provided by a provider of an operating system of the information processing apparatus, the control method including: acquiring paper detailed information including at least information indicating properties of paper which is used in the printing apparatus, receiving a change regarding at least one of paper type information, which is information indicating a type of the paper, and the paper detailed information, and transmitting information concerning the change to the printing apparatus.

### BACKGROUND

### Field of the Technology

The present disclosure relates to an information processing apparatus, a control method, and a storage medium.

### Description of the Related Art

There is a known configuration which uses a printer driver installed on a host computer as control software for a printing apparatus to issue a print instruction to the printing apparatus connected to the host computer. The host computer has an operating system (OS), serving as basic software, installed thereon, and the printer driver is configured in compliance with specifications defined by the OS and is invoked by the OS to run. The vendor (manufacturer) which provides a printing apparatus provides a printer driver compatible with specifications defined by an OS and is thus able to provide a method or unit for issuing an instruction for printing to the printing apparatus with use of the OS.

In recent years, in Windows®, a standard class driver (hereinafter also referred to as a “standard driver”) which is able to be used in common by respective printing apparatuses provided by a plurality of vendors has been provided. Such a standard driver is included in the package of an OS and easily becomes usable by connecting an optional printing apparatus to a host computer. Therefore, it is not necessary to separately install a device-specific printer driver adapted for the printing apparatus, so that the standard driver is highly convenient.

Moreover, the standard driver is configured in such a way as to allow designating a print function according to PrintCapabilities generated based on information acquired from the connected printing apparatus. This enables a user who uses the standard driver to, regardless of currently using one standard driver, designate a print function corresponding to the capability of the connected printing apparatus.

The standard driver allows an application for function extension (hereinafter also referred to as an “extension application”) to be associated therewith. The extension application can be provided by a vendor which provides the printing apparatus. By editing print device capabilities (PDC) generated by the standard driver, the extension application is able to provide functions which are not able to be implemented by the standard driver alone.

Japanese Patent Laid-Open No. 2020-9055 describes a technique which, by using the extension application, provides a print setting screen available for receiving settings of page layout printing (N-in-1 function or N-up function) from the user.

However, even in a case where an extension application such as that described in Japanese Patent Laid-Open No. 2020-9055 is used, functions which the extension application provides are still restricted.

### SUMMARY

According to an aspect of the present disclosure, a non-transitory computer-readable storage medium stores an application program which causes an information processing apparatus, which is connected to a printing apparatus, to perform a control method, the application program cooperating with a standard driver which is provided by a provider of an operating system of the information processing apparatus, the control method including: acquiring paper detailed information including at least information indicating properties of paper which is used in the printing apparatus, receiving a change regarding at least one of paper type information, which is information indicating a type of the paper, and the paper detailed information, and transmitting information concerning the change to the printing apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a printing system according to a first embodiment.

FIGS. 2A and 2B are configuration diagrams of the printing system according to the first embodiment.

FIGS. 3A and 3B are flowcharts illustrating processing for adding paper detailed information to print function information (Print Device Capabilities (PDC)).

FIG. 4A is a diagram illustrating an example of capability information in which attribute information, which a printing apparatus returns with media-col-database, has been reflected.

FIG. 4B is a diagram illustrating an example of capability information in which attribute information, which is transmitted to the printing apparatus with media-col-database, has been reflected.

FIG. 5A is a diagram illustrating an example in which capability information in which attribute information, which the printing apparatus returns with media-col-database, has been reflected has been written in Extensible Markup Language (XML) format based on a format which an operating system (OS) defines.

FIGS. 5B1 and 5B2 are diagrams illustrating an example in which capability information in which attribute information, which the printing apparatus returns with media-col-database, has been reflected has been written in XML format based on a format which the OS defines.

FIGS. 5C1 and 5C2 are diagrams illustrating an example in which capability information in which attribute information, which the printing apparatus returns with media-col-database, has been reflected has been written in XML format based on a format which the OS defines.

FIG. 6A is a diagram illustrating an example of a print setting screen which a print setting screen extension unit displays.

FIG. 6B is a diagram illustrating an example of a paper type setting screen which the print setting screen extension unit displays.

FIG. 6C is a diagram illustrating an example of a paper information editing screen which the print setting screen extension unit displays.

FIG. 6D is a diagram illustrating an example of a paper type setting screen which the print setting screen extension unit displays.

FIGS. 7A and 7B are diagrams illustrating an example of a PrintTicket in which paper sizes and paper types have been selected as paper information.

FIG. 8 is a diagram illustrating a transition example of menu screens each of which is displayed on an operation panel of the printing apparatus.

FIG. 9 is a diagram illustrating an example of paper information which is displayed in a web browser setting screen of the printing apparatus.

FIG. 10 is a configuration diagram of a printing system according to a third embodiment.

### DESCRIPTION OF THE EMBODIMENTS

Various embodiments, features, and aspects of the present disclosure will be described in detail below with reference to the drawings. Furthermore, the following embodiments should not be construed to limit the present disclosure set forth in claims, and not all of the combinations of features described in the embodiments are essential for solutions in the present disclosure.

Furthermore, the same constituent elements are assigned the respective same reference characters, and any duplicated description thereof is omitted.

### First Embodiment

### <Hardware Configuration of Printing System>

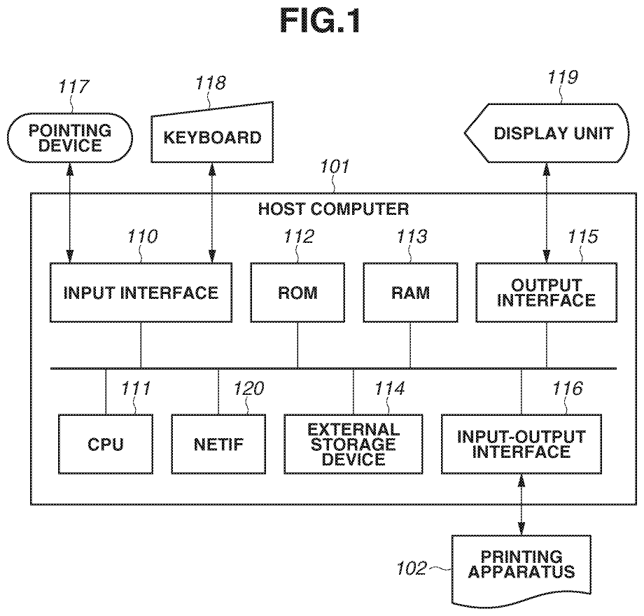

FIG. 1 is a block diagram illustrating a hardware configuration of a printing system according to a first embodiment. Referring to FIG. 1, a host computer 101, which is an example of an information processing apparatus, includes an input interface 110, a central processing unit (CPU) 111, a read-only memory (ROM) 112, a random access memory (RAM) 113, an external storage device 114, an output interface 115, an input-output interface 116, and a network interface (hereinafter referred to as an “NETIF”) 120.

Moreover, to the input interface 110, input devices, such as a keyboard 118 and a pointing device 117, are connected, and, to the output interface 115, a display device such as a display unit 119 is connected.

The NETIF 120 performs control to perform data transfer with external equipment via a network.

An initialization program is stored in the ROM 112. An application program group, an operating system (OS), print data generation software, and other various pieces of data are stored in the external storage device 114. The RAM 113 is used as, for example, a work memory to be used for execution of various programs stored in the external storage device 114, so that the various programs are able to run in the host computer 101.

Furthermore, in the first embodiment, the CPU 111 performs processing according to procedures of a program stored in the ROM 112, thus executing the respective functions described below in the host computer 101 and performing processing operations illustrated in the respective flowcharts described below. A printing apparatus 102, which is an example of an image processing device, is connected to the host computer 101 via the input-output interface 116 in such a way as to be able to communicate with the host computer 101.

While, here, the host computer 101 and the printing apparatus 102 are configured separately from each other, these can also be configured integrally with each other as a single information processing apparatus. Furthermore, while an example in which the printing apparatus 102 is an inkjet printer which performs printing by discharging ink onto a paper surface is described, printing can be performed by another method (for example, an electrophotographic method). Moreover, the host computer 101 can be a desktop personal computer, a smartphone, or a notebook personal computer.

### <Configuration of Printing System Centering on Software>

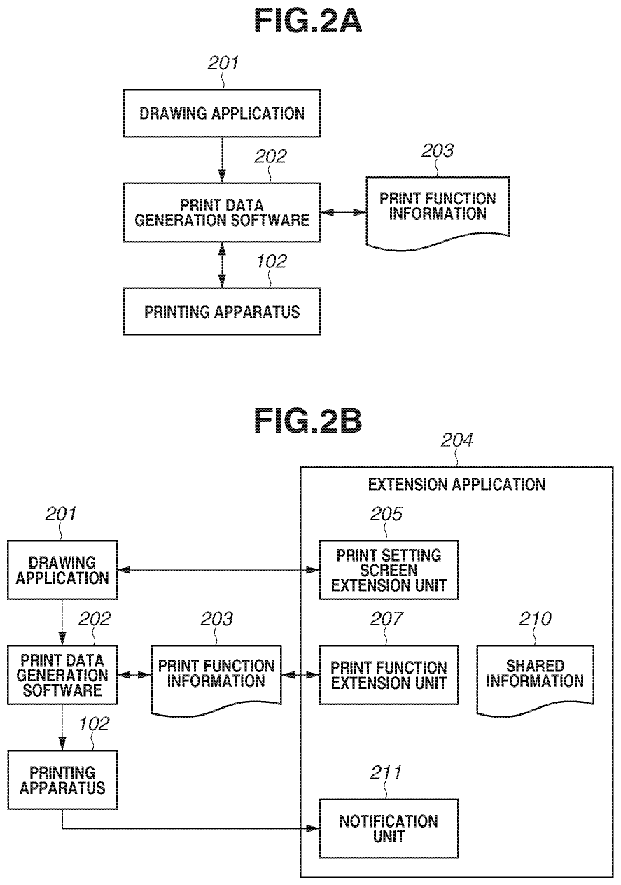

FIGS. 2A and 2B are diagrams schematically illustrating a configuration of the printing system centering on software. Here, a printing system using a host computer 101 loaded with Windows® of Microsoft® serving as an OS is described as a premise. FIG. 2A is a diagram illustrating a general configuration employed in a case where an extension application 204 is not associated with print data generation software 202 and the printing apparatus 102.

Moreover, in the present specification, a print module included in the OS (which can include the print data generation software 202) may be referred to as “print software”. In the first embodiment, processing which the information processing apparatus performs in response to instructions from the print data generation software 202 can be performed in response to instructions from the print software or the OS. Similarly, an operation which the extension application 204 performs on the print data generation software 202 can be set as an operation which is performed on the print software or the OS.

A drawing application 201 is software for creating content to be printed (drawing data). For example, a document creation application or a spread sheet application is equivalent to the drawing application 201. Upon receiving a print request from the user, the drawing application 201 issues a print instruction to the OS. The print instruction includes print setting information for issuing an instruction for operations of the print data generation software 202 and the printing apparatus 102. The print setting information is also called PrintTicket (hereinafter also referred to as “PT”).

The drawing application 201 201 is able to cause a print setting screen, which any one of the print data generation software 202, the OS, and the drawing application 201 provides, to be displayed to output the print setting information. The print setting screen includes an object (hereinafter also referred to as a “control item”) indicating a print function settable according to capability information (information settable as print settings) which is acquired from the print data generation software 202 and a control item indicating setting values of the print function. The capability information is also called PrintCapabilities (hereinafter also referred to as “PC”).

The print data generation software 202 determines a PC based on print function information 203. The print function information 203 is data indicating all of the settable print functions, setting values thereof, and print functions in which an exclusive relationship between the setting values is described. The print function information 203 is also called Print Device Capabilities (PDC).

The print function information (PDC) 203 is included in a configuration file of the print data generation software 202, and is arranged as a non-modifiable file in the external storage device 114. Alternatively, the PDC 203 is also able to be dynamically generated by the print data generation software 202. At this time, the generated PDC 203 is editable. Specifically, the print data generation software 202 or the OS can be configured to acquire, from the printing apparatus 102, printing apparatus attribute data and generate the PDC 203 according to attribute information included in the acquired attribute data.

The print data generation software 202 uses an API of the OS and thus causes the OS or the print software to issue a GetPrinterAttributes operation of the IPP. Furthermore, API is an abbreviation for application programming interface, and IPP is an abbreviation for Internet Printing Protocol. After that, the OS or the print software acquires attribute data from the printing apparatus 102 based on GetPrinterAttributes.

A response to GetPrinterAttributes contains attribute information indicating a print function able to be designated by the printing apparatus 102 (printing apparatus capabilities) and setting values related to the attribute information. Such response is then stored in the RAM 113.

Furthermore, it is also possible to rewrite the setting values acquired with GetPrinterAttributes to update attribute data about the printing apparatus 102. The print data generation software 202 rewrites setting values related to attribute information to be updated, included in a response received from the printing apparatus 102 and stored in the RAM 113.

Next, the print data generation software 202 uses an API of the OS and thus causes the print software or the OS to issue a SetPrinterAttributes operation of the IPP. The OS or the print software transmits, to the printing apparatus 102, attribute data to be updated, based on SetPrinterAttributes. The printing apparatus 102 rewrites and updates attribute information indicating the capabilities of the printing apparatus 102 and setting values related to the attribute information, based on the attribute data transmitted from the print data generation software 202.

With this configuration, the print data generation software 202 can be configured to allow the user to designate a print function which is available in each printing apparatus 102 according to the connected printing apparatus 102. In other words, even in a case where a printing apparatus having a different function or a printing apparatus developed by a different vendor has been connected, the print data generation software 202 can be configured to allow the user to designate a print function which is available according to the connected printing apparatus.

Furthermore, here, a configuration in which an IPP Class Driver included with Windows® is used as the print data generation software 202 is described.

The IPP Class Driver is a printer driver for performing print processing according to the specifications of a standard printing protocol called IPP, and is included in the package of an OS.

Each of an IPP Class Driver and an UP Class Driver is not a unique printer driver associated with the type of the printing apparatus 102 but a standard class driver which is capable of transmitting print data to any one of a plurality of printing apparatuses which a plurality of different manufactures respectively provides. The IPP Class Driver is a standard driver which performs local printing according to the above-mentioned specifications. Moreover, a configuration using a Universal Print (UP) Class Driver, which is a standard driver which performs cloud printing according to the above-mentioned specifications, can be employed.

Furthermore, in a case where cloud printing is performed with use of the UP Class Driver, print data is not directly transmitted to a printing apparatus, but is transmitted via a cloud printing-related service to cause the printing apparatus to perform printing. Moreover, each of the IPP Class Driver and the UP Class Driver acquires attribute information about the connected printing apparatus 102 in such a way as to allow the user to designate a print function which the connected printing apparatus 102 supports, and generates the print function information 203 based on the acquired attribute information.

The OS generates intermediate data (also referred to as “input data”) based on a print instruction output from the drawing application 201, and passes the intermediate data to the print data generation software 202. Furthermore, the data which the drawing application 201 outputs for printing is data of the Graphic Device Interface format (GDI-format data) or data of Extensible Markup Language (XML) Paper Specification format (XPS-format data).

In the case of using the print data generation software 202, if the data which the drawing application 201 outputs is data of the GDI format, the OS converts the data of the GDI format output from the drawing application 201 into data of the XPS format. Then, the OS passes the data of the XPS format obtained by conversion to the print data generation software 202 as intermediate data. If the data which the drawing application 201 outputs is data of the XPS format, the OS passes the data of the XPS format to the print data generation software 202 as intermediate data.

Furthermore, the intermediate data includes drawing data, which is information about a picture to be formed on a paper surface, and print setting information, which has been set by the user.

The print data generation software 202 converts the acquired intermediate data into print data which the printing apparatus 102 is able to interpret, and transmits the print data to the printing apparatus 102. Furthermore, the print data includes drawing data, which is information about a picture to be formed on a paper surface, and print setting attribute information (attribute information for designating print settings), which has been generated based the print setting information set by the user. The print setting attribute information includes attribute information indicating functions which are able to be designated at the printing apparatus 102 (printing apparatus capabilities) and setting values related to the attribute information.

The printing apparatus 102 performs printing on a paper surface based on print data transmitted from the print data generation software 202. At this time, the printing apparatus 102 forms, on a paper surface, drawing data included in the print data by an operation conforming to print setting attribute information included in the print data. The print setting attribute information includes attribute information for designating, for example, a print quality (such as image quality priority or speed priority) or duplex printing and setting values thereof. For example, in a case where attribute information designating duplex printing is included in the print setting attribute information, the printing apparatus 102 performs duplex printing.

FIG. 2B is a diagram illustrating a configuration employed in a case where the extension application 204 is associated with the print data generation software 202 and the printing apparatus 102. Furthermore, constituent elements and processing operations which are not particularly mentioned in the following description are equivalent to those illustrated and described in FIG. 2A.

The extension application 204 is software for extending the function of the print data generation software 202, and is software not preliminarily included in (not included with) the OS. Therefore, it is necessary for the user to operate the host computer 101 to download the extension application 204 from a server being an external device via the Internet and install the extension application 204 on the host computer 101. The extension application 204 is an example of an application program which cooperates with print software including an IPP Class Driver.

Alternatively, the extension application 204 can be configured to be automatically installed based on the printing apparatus 102 having been connected to the host computer 101. Specifically, in a case where the printing apparatus 102 has been connected to the host computer 101, the OS can acquire device identification information from the printing apparatus 102. The OS can download the extension application 204 corresponding to the acquired device identification information from a server via the Internet and install the downloaded extension application 204 on the host computer 101. Thus, the print data generation software 202 and the extension application 204 are retained as separate files in the host computer 101.

Furthermore, the print data generation software 202 and the extension application 204 may be updated for upgrading, these update processing operations are performed at respective different timings. Thus, timing at which the print data generation software 202 is acquired by the host computer 101 and timing at which the extension application 204 is acquired by the host computer 101 are different from each other. Moreover, a trigger at which the print data generation software 202 is acquired by the host computer 101 and a trigger at which the extension application 204 is acquired by the host computer 101 are also different from each other.

Furthermore, in a case where the extension application 204 has been installed, the OS associates the extension application 204 with the print data generation software 202 and the printing apparatus 102.

The extension application 204, which is described in the first embodiment, includes a print setting screen extension unit 205, a print function extension unit 207, and a notification unit 211. Moreover, the extension application 204 further includes shared information 210, which is accessible in common from the print setting screen extension unit 205, the print function extension unit 207, and the notification unit 211. The entity of the shared information 210 is files saved in the external storage device 114 or information stored in the RAM 113.

The extension application 204 is capable of, with use of an application programming interface (API) which the OS provides, freely performing write and readout of information to and from the shared information 210. Moreover, the shared information 210 is allocated as a region available for storing information for each individual application and is able to store information other than attribute data about the printing apparatus 102.

The shared information 210 is information different from the PDC 203, which is generated by the print data generation software 202 or the OS to designate a print function available for the connected printing apparatus 102.

Furthermore, the extension application 204 can be configured to end an operation thereof each time a processing operation of each unit ends. In that case, each time a request for using each unit is received, the OS activates the extension application 204. Moreover, other forms are also possible. For example, while, as a processing operation of the print setting screen extension unit 205 ends, the OS causes the operation of the extension application 204 to end, a configuration in which, even if the processing operation of the print function extension unit 207 ends, the OS keeps the extension application 204 activated can be employed.

Additionally, the extension application 204 can cancel the processing operation thereof during a processing operation of each unit. In a case where the processing operation of the extension application 204 has been cancelled, a job which is in the process of being processed on a print queue is deleted by the OS.

Upon receiving a print request from the user, the drawing application 201 issues a print instruction to the OS. Even under this configuration, as with the configuration illustrated in FIG. 2A, the drawing application 201 is able to cause a print setting screen to be displayed. Under this configuration, a print setting screen which the extension application 204 provides is displayed. Specifically, a print setting screen which the print setting screen extension unit 205 included in the extension application 204 provides is displayed.

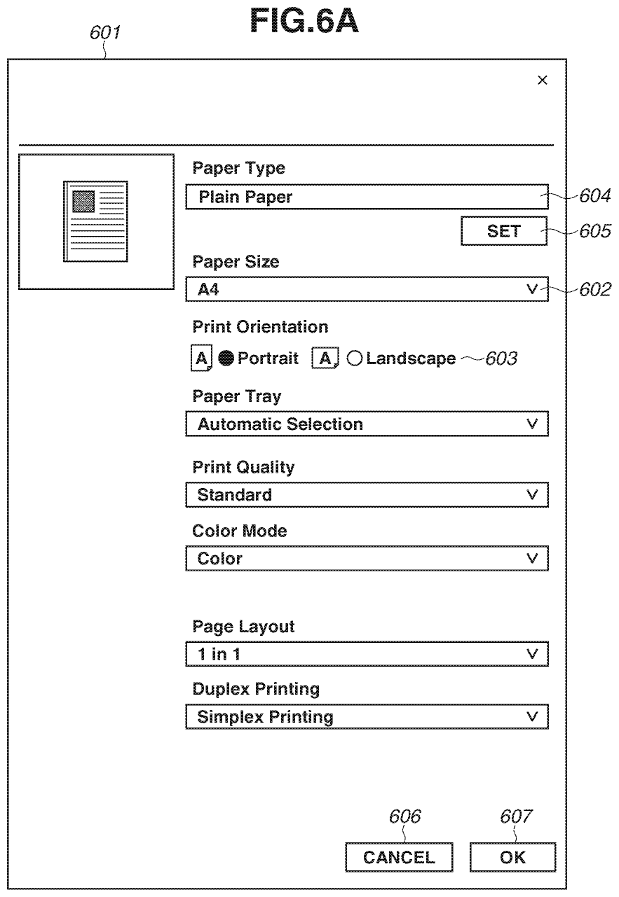

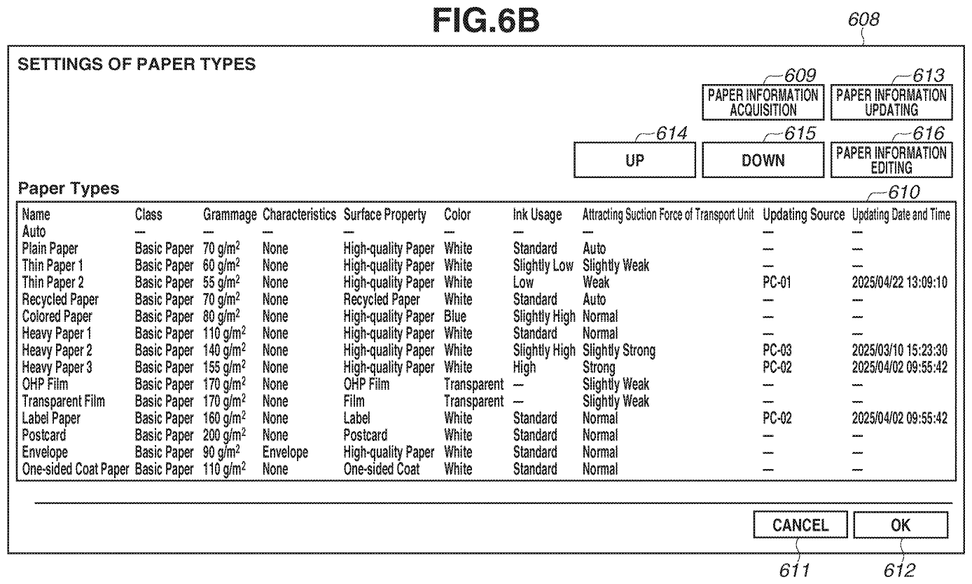

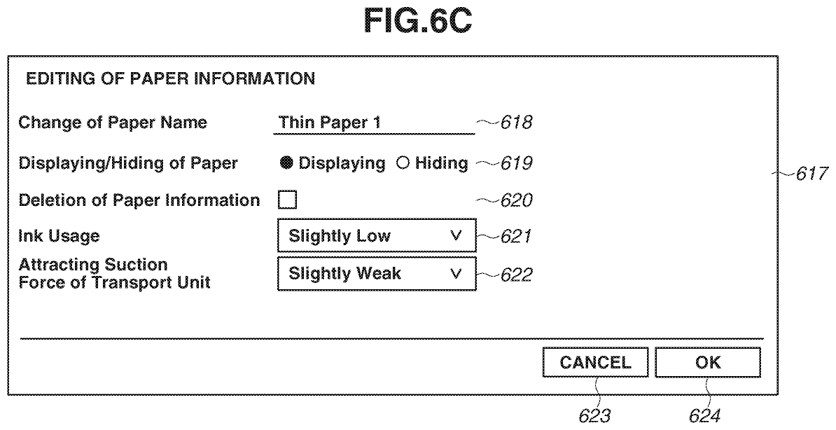

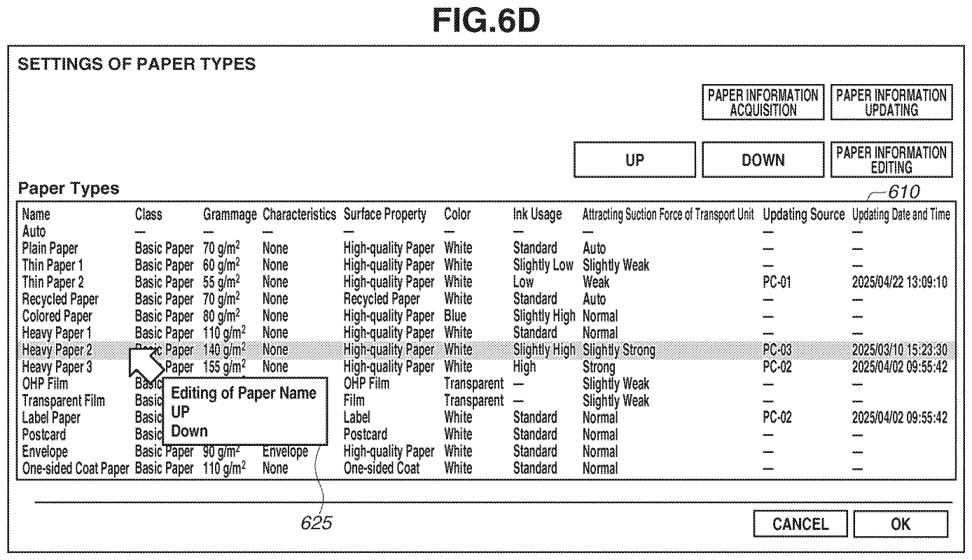

Furthermore, whether the print setting screen which the print setting screen extension unit 205 provides is to be displayed depends on an operation performed by the user. For example, suppose a case where the drawing application 201 is a document creation application or a spread sheet application. In this case, in response to a property setting button displayed on a print setting screen which the document creation application or the spread sheet application provides being pressed by the user, a print setting screen which the print setting screen extension unit 205 provides is displayed. The details of the print setting screen extension unit 205 are described below with reference to FIG. 6A, FIG. 6B, FIG. 6C, and FIG. 6D.

Moreover, in response to the drawing application 201 receiving a print request from the user and a print instruction being issued to the OS, the OS generates intermediate data based on the print instruction output from the drawing application 201 and then passes the intermediate data to the print data generation software 202.

The intermediate data is processed by the print data generation software 202 into print data which the printing apparatus 102 is able to interpret, and the print data is then passed to the printing apparatus 102 via the OS. The printing apparatus 102 performs printing on a paper surface based on the received print data. Furthermore, to convert the intermediate into the print data, a function which the OS provides can be used.

Moreover, the extension application 204 includes a print function extension unit 207. The print function extension unit 207 is able to edit the PDC 203, which the print data generation software 202 or the OS has generated. With this configuration, the print function extension unit 207 is able to perform, for example, addition of a function which the extension application 204 provides and addition of a function which the printing apparatus 102 supports but the print data generation software 202 does not support. Moreover, the print function extension unit 207 is able to perform, for example, addition of a mutually exclusive relationship between setting values of print functions.

The OS activates the print function extension unit 207 at the time when the extension application 204 has been associated with the printing apparatus 102 and the print data generation software 202 for the first time. Additionally, the OS can be configured to activate the print function extension unit 207 at the other timing such as the time of activation of the OS. With this configuration employed, even in a case where, for example, a new paper type is added later to the printing apparatus 102 so that a function related to printing is extended, the print function extension unit 207 is able to detect the extended function and add the extended function to the PDC 203.

Moreover, the extension application 204 includes a notification unit 211. The notification unit 211 is able to display a notification to the user in response to the occurrence of an error in the printing apparatus 102.

For example, in response to an out-of-paper error occurring in the printing apparatus 102, the print data generation software 202 detects the out-of-paper error and the OS causes the display unit 119 to display a message with use of a notification function called a toast notification, which is a function of the OS. In response to the user pressing the toast notification, the notification unit 211 of the extension application 204 is invoked by the OS, so that a user interface (UI) screen of the notification unit 211 is displayed. In the UI screen of the notification unit 211, displaying of, for example, a detailed message about the out-of-paper error or a paper loading method can be performed.

Furthermore, if the extension application 204 has once transmitted print data to the printing apparatus 102, the extension application 204 becomes unable to perform screen displaying of, for example, a guide associated with the print data in the middle of a processing operation of each unit.

Moreover, the configuration of the extension application 204 for implementing the first embodiment is not limited to a configuration including all of the above-mentioned functions (units), but can be a configuration including only some of the functions or a configuration additionally including another function. Moreover, the extension application 204 may be simply called print software. As described above, it can be said that the extension application 204 includes at least one of the print setting screen extension unit 205, the print function extension unit 207, and the notification unit 211.

The present disclosure is directed to increasing the user's convenience in the case of using an application which supports a standard driver preliminarily built in the OS, such as the extension application 204.

### <Addition of Paper Detailed Information to Print Function Information by Print Function Extension Unit>

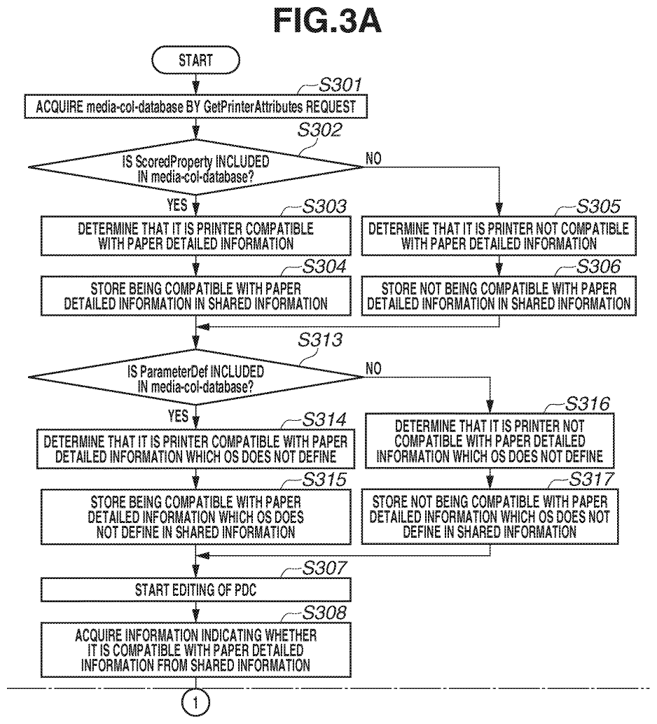

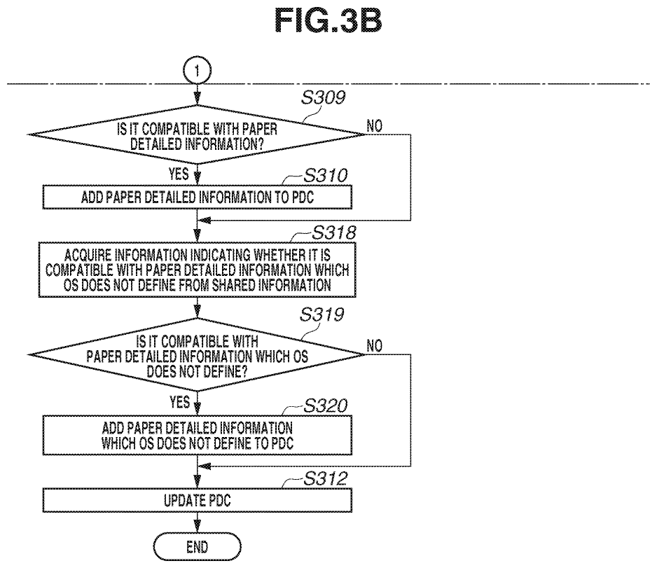

A flow of processing which the print function extension unit 207 of the extension application 204 performs to add paper detailed information to the print function information 203 is described with reference to FIGS. 3A and 3B.

The flow of processing illustrated in FIGS. 3A and 3B is started by a print queue associated with the extension application 204 being selected by the user and the print setting screen extension unit 205 included in the extension application 204 being activated by the user. Alternatively, the flow of processing illustrated in FIGS. 3A and 3B can be started not by the extension application 204 being optionally activated by the user but by the extension application 204 being directly activated by the OS.

In step S301, the print function extension unit 207 of the extension application 204 acquires attribute information from the printing apparatus 102. The print function extension unit 207 designates attribute information to be acquired from the printing apparatus 102 and causes, with use of an API of the OS, the OS or the print software to issue a GetPrinterAttributes operation of the IPP. The OS or the print software generates a GetPrinterAttributes request and then passes the GetPrinterAttributes request to the printing apparatus 102.

The printing apparatus 102 generates a response based on the received GetPrinterAttributes request and then passes the response to the print function extension unit 207 via the OS or the print software. The attribute information is acquired as such a response passed from the printing apparatus 102. A processing operation in step S301 is an example of an acquisition process.

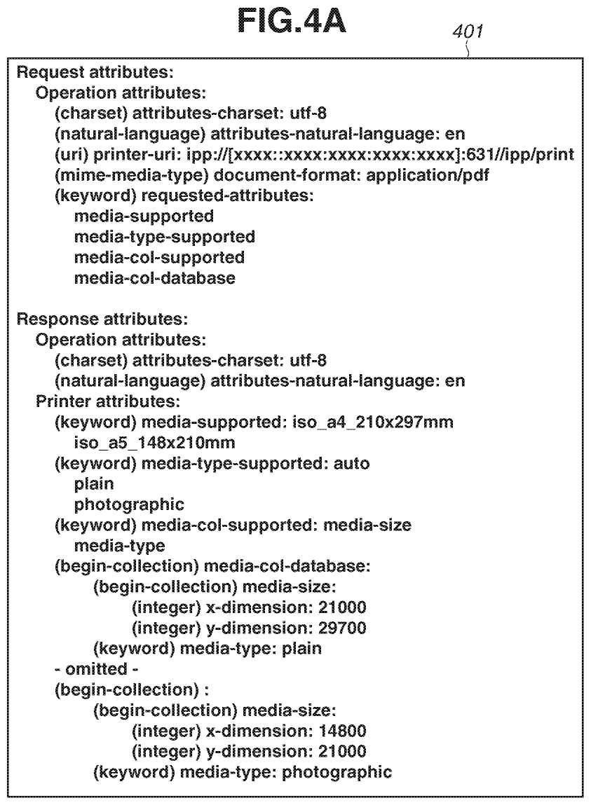

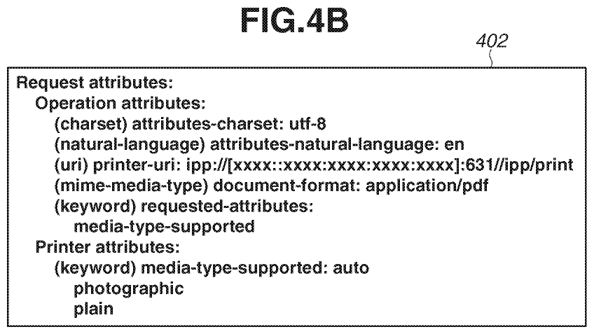

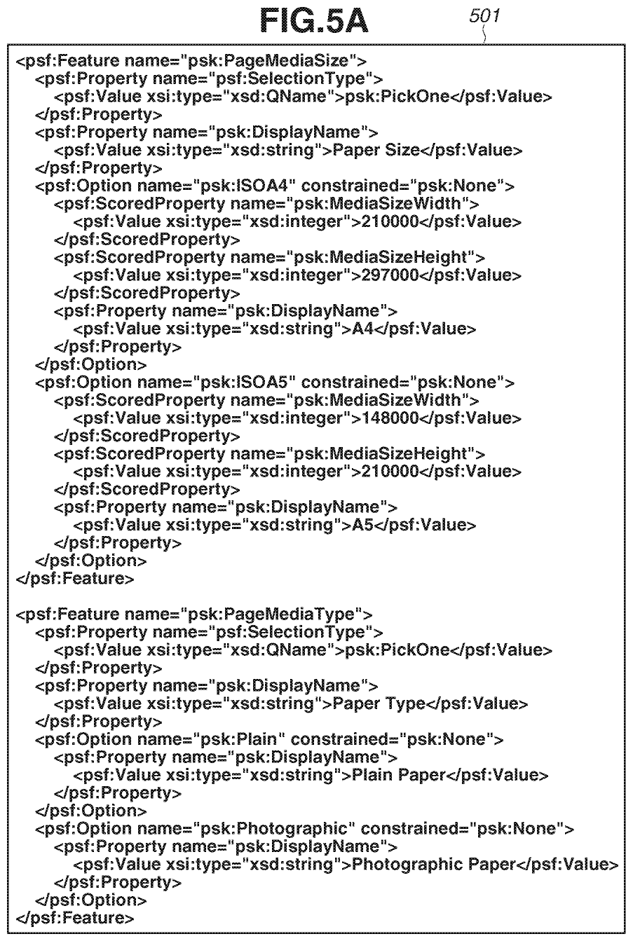

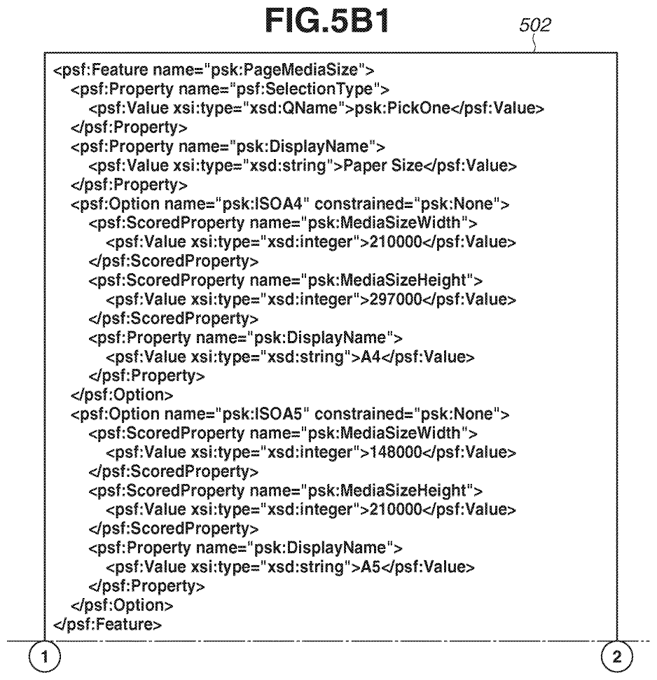

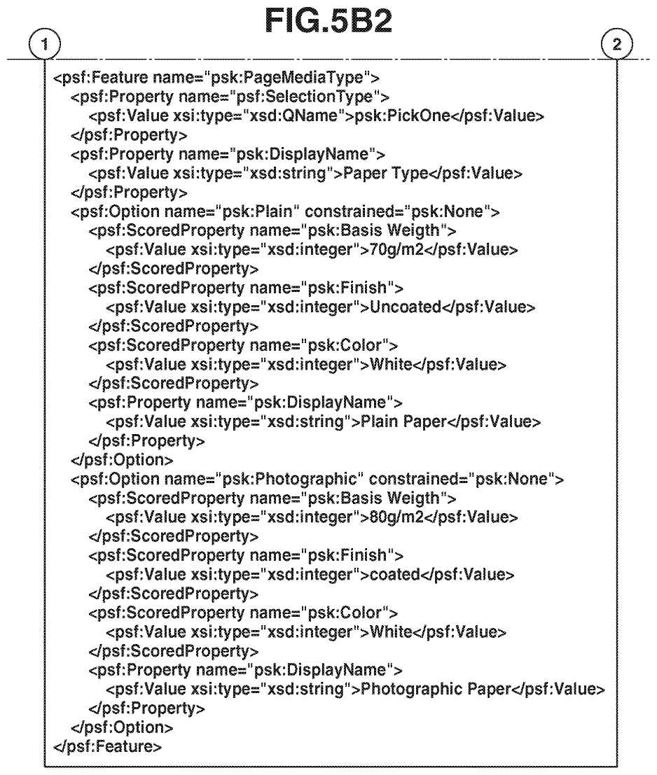

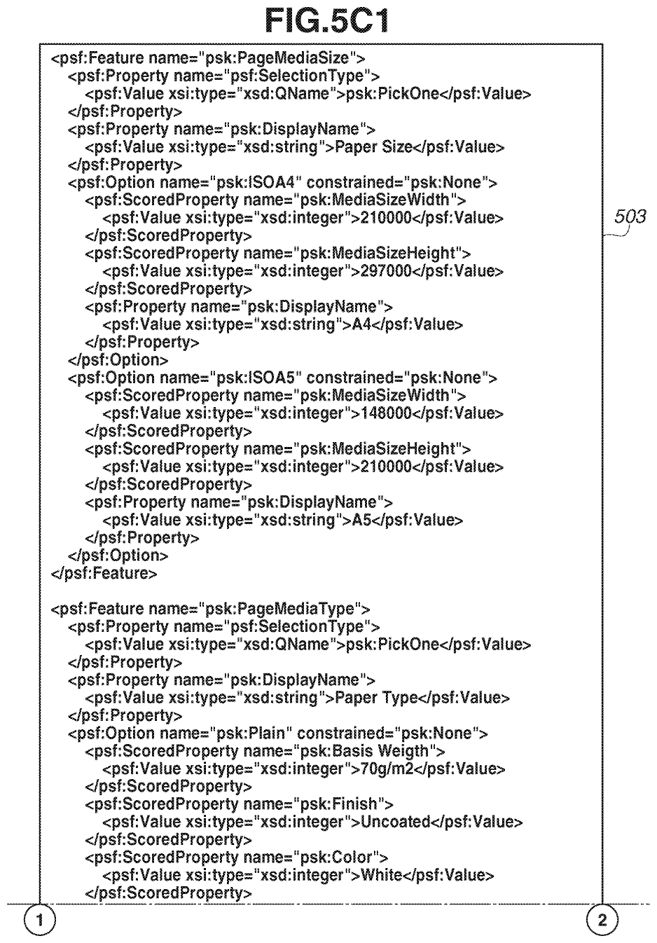

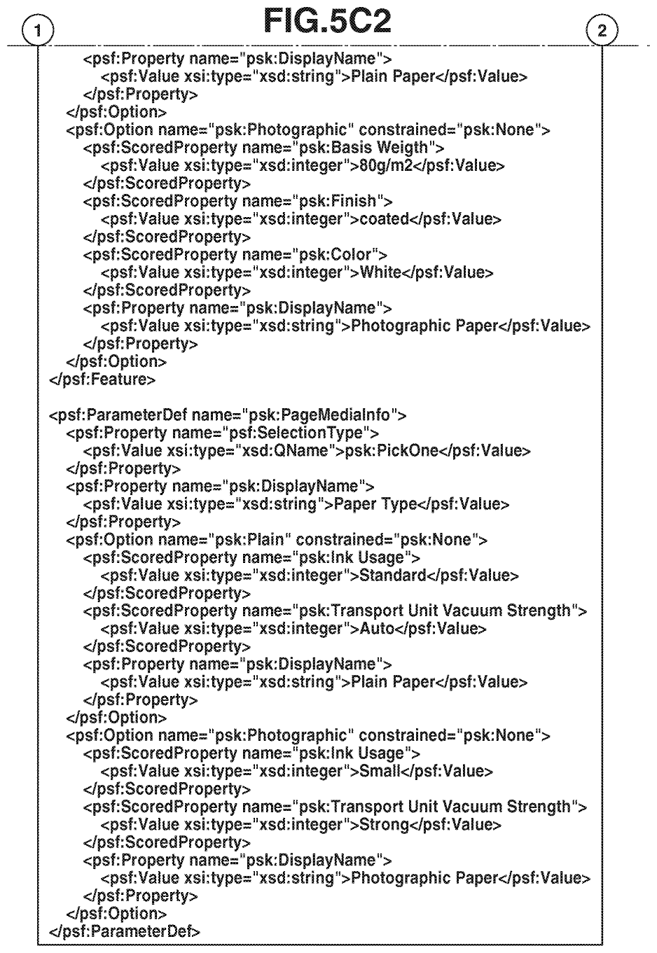

While the attribute information able to be acquired as a response from the printing apparatus 102 includes a plurality of pieces of attribute information, in the first embodiment, it is assumed that the print function extension unit 207 acquires a media-col-database attribute value. In the media-col-database attribute value, detailed information concerning paper settings available for printing to be performed by the printing apparatus 102. An example of capability information in which information which the printing apparatus 102 returns with the media-col-database attribute value has been reflected is described with reference to FIG. 4A and FIG. 5A.

Capability information 401 illustrated in FIG. 4A is written as a part of capability information in which attribute information concerning paper information available for printing which the printing apparatus 102 returns with the media-col-database attribute value has been reflected.

The print data generation software 202 acquires, from the printing apparatus 102, attribute information written in requested-attributes of Request attributes. A response from the printing apparatus 102 is written in Response attributes.

Here, the print data generation software 202 acquires, from the printing apparatus 102, paper sizes, paper types, and combinations thereof. Thus, the capability 401 contains attribute information about paper sizes (an item in which “media-supported” is written) and attribute information about paper types (an item in which “media-type-supported” is written).

Moreover, setting values related to paper sizes can include, for example, A4 (“media-supported” in which “iso_a4_210×297 mm” is written) and A5 (“media-supported” in which “iso_a5_148×210 mm” is written).

Setting values related to paper types can include, for example, plain paper (“media-type-supported” in which “plain” is written) and photographic paper (“media-type-supported” in which “photographic” is written). The paper sizes and paper types can include setting values other than the above-mentioned setting values, or do not need to include the above-mentioned setting values.

Capability information 501 illustrated in FIG. 5A is information obtained by writing the capability information 401 illustrated in FIG. 4A in XML format based on the format which the OS defines. The print function extension unit 207 provides a print setting screen to the print setting screen extension unit 205 based on information written in the capability information 501.

Furthermore, here, it is assumed that the print data generation software 202 includes, as setting items of paper information, functions of paper sizes and paper types. Thus, the capability information 501 contains settings of paper sizes (corresponding to an item in which “PageMediaSize” is written in “Feature”) and settings of paper types (corresponding to an item in which “PageMediaType” is written in “Feature”).

Moreover, the print data generation software 202 can contain, as options corresponding to setting items of paper sizes, for example, A4 (“Option” in which “ISOA4” is written) and A5 (“Option” in which “ISOA5” is written). The print data generation software 202 can contain, as options corresponding to setting items of paper types, for example, plain paper (“Option” in which “Plain” is written) and photographic paper (“Option” in which “Photographic” is written). The paper sizes and paper types can include options other than the above-mentioned options, or do not need to include the above-mentioned options.

Furthermore, while, in actuality, the setting items of paper information for the print data generation software 202 also include paper information other than the above-mentioned two pieces of paper information (for example, settings of margins), here, for ease of explanation, paper information other than the above-mentioned two pieces of paper information is omitted from description.

Next, a case where capability information 502 illustrated in FIGS. 5B1 and 5B2 contains detailed information other than the paper information written in the capability information 501 illustrated in FIG. 5A is described. In this case, a parameter “ScoredProperty” is provided, and detailed information is written in the parameter “ScoredProperty”.

Specifically, as illustrated in FIGS. 5B1 and 5B2, as setting values corresponding to items of plain paper and photographic paper, grammages (basis weights), surface properties, and colors are written in sections “Option”. Furthermore, in the section “Option”, “Basis Weight” for grammage, “Finish” for surface property, and “Color” for color are written as the respective names of the parameters “ScoredProperty”. Pieces of paper information other than the paper detailed information are written as usual as with FIG. 5A.

Furthermore, there is a case where pieces of capability information 502 and 503 illustrated in FIGS. 5B1 and 5B2 and FIGS. 5C1 and 5C2, respectively, contain, in addition to the grammage, surface property, and color of each paper type, information concerning characteristics of paper. In this case, in paper detailed information on a paper type setting screen 608 illustrated in FIG. 6B, for example, the envelope is written as “Envelope” as the characteristics of paper. Besides, the punched paper is written as “Punched Paper” as the characteristics of paper. In a case where the capability information 502 or 503 contains information concerning characteristics of paper types, for example, the parameter “ScoredProperty” in which “Sheet Type” is written is written in the section “Option”.

Information indicating the grammage, surface property, color, and characteristics of paper is an example of information indicating the property of paper. Furthermore, the information indicating the property of paper can contain information other than the information indicating the grammage, surface property, color, and characteristics of paper, or can be some pieces of information included in the information indicating the grammage, surface property, color, and characteristics of paper.

Additionally, in the capability information 503 illustrated in FIGS. 5C1 and 5C2, paper information which is not written in the capability information 501 illustrated in FIG. 5A and the capability information 502 illustrated in FIG. 5B1 and 5B2 is written. This paper information is defined in the IPP but is attribute information concerning vendor-specific paper information which the OS is not able to interpret. In this case, a parameter “ParameterDef” is provided, and such paper information is written in the parameter “ParameterDef”.

With this writing employed, by using the extension application 204, even information which the OS is not able to interpret becomes able to be displayed in list form as paper detailed information as illustrated in FIG. 6B described below.

Specifically, as illustrated in FIGS. 5C1 and 5C2, items of paper information (“ParameterDef” of “PageMediaInfo”) and options thereof are written as the parameter “ScoredProperty” in the parameter “ParameterDef”. For example, with regard to the ink usage shown in FIG. 6B, in the capability information 503, “Ink Usage” is written as the parameter “ScoredProperty”. Additionally, with regard to the attracting suction force of a transport unit, “Transport Unit” is written as the parameter “ScoredProperty”. Paper information which the OS is able to interpret is also similarly written as mentioned above with reference to FIG. 5A and FIGS. 5B1 and 5B2.

The ink usage is an example of information concerning image processing which is performed in the printing apparatus 102, and the information indicating the attracting suction force of a transport unit is an example of information concerning control of the printing apparatus 102.

In the first embodiment, information indicating the property of paper, information concerning image processing which is performed in the printing apparatus 102, and information concerning control of the printing apparatus 102 are collectively defined as paper detailed information. Furthermore, the paper detailed information is assumed to include at least information indicating the property of paper. Moreover, items included in the paper detailed information are not limited to those illustrated in the first embodiment. The paper detailed information can include information other than the items mentioned in the first embodiment, or can include only some items of the items mentioned in the first embodiment.

Moreover, the paper detailed information can contain both information which the OS is able to interpret and information which the OS is unable to interpret, or can contain only any one of such pieces of information.

Furthermore, while, in the present disclosure, a configuration in which, in step S301, the print function extension unit 207 of the extension application 204 acquires paper detailed information from the printing apparatus 102 has been described, the first embodiment is not limited to this configuration.

For example, the extension application 204 can preliminarily store at least one of information concerning image processing which is performed in the printing apparatus 102 (the details of which are described below) and information concerning control of the printing apparatus 102 (the details of which are described below). In this case, at the time of installing the extension application 204 on the host computer 101 (information processing apparatus), paper detailed information is then stored in the host computer 101 (information processing apparatus) together with the extension application 204.

Alternatively, the paper detailed information, which is acquired in step S301, can be acquired from an external device different from the printing apparatus 102, such as a server system.

The description refers back to FIGS. 3A and 3B. In step S301 illustrated in FIG. 3A, the print function extension unit 207 acquires attribute information including paper information from the printing apparatus 102, and then advances the processing to step S302. Each of the pieces of capability information 501, 502, and 503 illustrated in FIG. 5A, FIGS. 5B1 and 5B2, and FIGS. 5C1 and 5C2, respectively, is capability information in which the acquired attribute information has been reflected.

In step S302, the print function extension unit 207 checks paper information acquired with the media-col-database attribute value. Specifically, the print function extension unit 207 determines whether a parameter “ScoredProperty” exists in settings of paper types (corresponding to an item in which “PageMediaType” is written in “Feature”). If, in step S302, it is determined that the parameter “ScoredProperty” exists (YES in step S302), the print function extension unit 207 determines the result of processing as YES, and then advances the processing to step S303.

In a case where the parameter “ScoredProperty” exists in settings of paper types included in the paper information, then in step S303, the print function extension unit 207 determines that the printing apparatus 102 to be connected is a printing apparatus compatible with the paper detailed information, and then advances the processing to step S304.

In step S304, the print function extension unit 207 stores, in the shared information 210, information indicating that the printing apparatus 102 to be connected is compatible with the paper detailed information, and then advances the processing to step S313.

On the other hand, if, in step S302, the print function extension unit 207 has determined the result of processing as NO (NO in step S302), the print function extension unit 207 advances the processing to step S305.

In a case where the parameter “ScoredProperty” does not exist in settings of paper types included in the paper information, then in step S305, the print function extension unit 207 determines that the printing apparatus 102 to be connected is a printing apparatus not compatible with the paper detailed information, and then advances the processing to step S306.

In step S306, the print function extension unit 207 stores, in the shared information 210, information indicating that the printing apparatus 102 to be connected is not compatible with the paper detailed information, and then advances the processing to step S313.

In step S313, the print function extension unit 207 checks paper information acquired with the media-col-database attribute value, and thus determines whether a parameter “ParameterDef” exists in the paper information. If, in step S313, it is determined that the parameter “ParameterDef” exists (YES in step S313), the print function extension unit 207 determines the result of processing as YES, and then advances the processing to step S314.

In a case where the parameter “ParameterDef” exists in the paper information, then in step S314, the print function extension unit 207 determines that the printing apparatus 102 to be connected is a printing apparatus compatible with paper detailed information which the OS does not define, and then advances the processing to step S315.

In step S315, the print function extension unit 207 stores, in the shared information 210, information indicating that the printing apparatus 102 to be connected is compatible with paper detailed information which the OS does not define, and then advances the processing to step S307.

On the other hand, if, in step S313, the print function extension unit 207 has determined the result of processing as NO (NO in step S313), the print function extension unit 207 advances the processing to step S316.

In a case where the parameter “ParameterDef” does not exist in the paper information, then in step S316, the print function extension unit 207 determines that the printing apparatus 102 to be connected is a printing apparatus compatible with only paper information which the OS defines, and then advances the processing to step S317.

In step S317, the print function extension unit 207 stores, in the shared information 210, information indicating that the printing apparatus 102 to be connected is not compatible with paper detailed information which the OS does not define, and then advances the processing to step S307.

Furthermore, in the first embodiment, it is supposed that the print function extension unit 207 stores the name of the printing apparatus 102 to be connected and information indicating whether the printing apparatus 102 to be connected is compatible with the paper detailed information and paper detailed information which the OS does not define while associating them with each other. However, the print function extension unit 207 can also store other information in the shared information 210. For example, the print function extension unit 207 can store, in the shared information 210, a list of combinations of the name of the printing apparatus 102 to be connected and paper information acquired with the media-col-database attribute value.

Alternatively, the print function extension unit 207 can store, in the shared information 210, the above-mentioned information in association with other information. For example, the other information includes the connection configuration of the printing apparatus 102 and the type of the printing apparatus 102 (such as an inkjet printer or a laser beam printer). Moreover, the other information can be, for example, information concerning paper size or paper type available for the printing apparatus 102 or information about a print function other than the function concerning available paper.

After, in step S315 or step S317, storing, in the shared information 210, information indicating whether the printing apparatus 102 is compatible with paper detailed information which the OS does not define, the print function extension unit 207 advances the processing to step S307.

In step S307, the print function extension unit 207 acquires the PDC 203 from the print data generation software 202 or the OS and starts editing processing for the PDC, and then advances the processing to step S308.

In step S308, the print function extension unit 207 acquires, from the shared information 210, information indicating whether the printing apparatus 102 is compatible with the paper detailed information. After acquiring the information from the shared information 210, the print function extension unit 207 advances the processing to step S309.

In step S309, the print function extension unit 207 determines whether the printing apparatus 102 to be connected is compatible with the paper detailed information, based on the information acquired from the shared information 210. If the result of determination in step S309 is YES (YES in step S309), the print function extension unit 207 advances the processing to step S310.

In step S310, the print function extension unit 207 edits the acquired PDC 203 and adds the paper detailed information to the PDC 203, and then advances the processing to step S318.

If, in step S309, the print function extension unit 207 has determined the result of processing as NO (NO in step S309), without adding the paper detailed information to the PDC 203 in step S310, the print function extension unit 207 advances the processing to step S318.

In step S318, the print function extension unit 207 acquires, from the shared information 210, information indicating whether the printing apparatus 102 is compatible with paper detailed information which the OS does not define. After acquiring the information from the shared information 210, the print function extension unit 207 advances the processing to step S319.

In step S319, the print function extension unit 207 determines whether the printing apparatus 102 to be connected is compatible with paper detailed information which the OS does not define, based on the information acquired from the shared information 210. If the result of determination in step S319 is YES (YES in step S319), the print function extension unit 207 advances the processing to step S320.

In step S320, the print function extension unit 207 edits the acquired PDC 203 and adds the paper detailed information which the OS does not define to the PDC 203, and then advances the processing to step S312.

If, in step S319, the print function extension unit 207 has determined the result of processing as NO (NO in step S319), without adding the paper detailed information which the OS does not define to the PDC 203 in step S320, the print function extension unit 207 advances the processing to step S312.

In step S312, the print function extension unit 207 updates the PDC 203 based on the pieces of information edited in step S310 and step S320 and other print setting information. PC (PrintCapabilities) is generated based on the PDC 203 edited by the print function extension unit 207. A print setting screen 601 illustrated in FIG. 6A described below is displayed based on the generated PC. In the print setting screen 601, a print function and another print function are selected by the user, and the print setting screen extension unit 205 reflects the selected print functions in PT (PrintTicket).

Moreover, in a case where, separately from reflection in PT, in a paper information editing screen 617 (the details of which are described below) illustrated in FIG. 6C, paper detailed information has been changed by the user, the print setting screen extension unit 205 notifies the print function extension unit 207 of the changed paper detailed information. The print function extension unit 207, which has received such notification, reflects the changed paper detailed information in the PDC 203 and, additionally, also reflects setting values of attribute information corresponding to the changed paper detailed information in the capability information 401 illustrated in FIG. 4A.

The print function extension unit 207 designates the changed attribute information and, with use of an API of the OS, causes the OS or the print software to issue a SetPrinterAttributes operation of the IPP. The OS or the print software generates a SetPrinterAttributes request including the capability information 401 in which the changed attribute information has been reflected, and then transmits the SetPrinterAttributes request to the printing apparatus 102. The changed attribute information, which is transmitted to the printing apparatus 102, is an example of information concerning a change regarding at least any one of paper type information and paper detailed information.

Capability information 402 illustrated in FIG. 4B is written as a part of capability information in which attribute information concerning paper information available for printing which is transmitted to the printing apparatus 102 with the media-col-database attribute value has been reflected.

Section “media-type-supported” written in Response attributes of the capability information 401 illustrated in FIG. 4A includes auto, plain, and photographic in this order. On the other hand, section “media-type-supported” written in Request attributes of the capability information 402 illustrated in FIG. 4B includes auto, photographic, and plain in this order. Thus, in a paper type setting screen 608 illustrated in FIG. 6B described below, an instruction for changing a display order has been issued by the user.

The printing apparatus 102 updates, by overwriting, attribute information and setting values related to the attribute information, which are stored in a database (not illustrated) included in the printing apparatus 102, based on attribute data transmitted from the print data generation software 202.

With the above-described processing operation of the print function extension unit 207, in a case where the printing apparatus 102 is compatible with paper detailed information, the paper detailed information becomes available for printing, and, in a case where the printing apparatus 102 is compatible with paper detailed information which the OS does not define, the paper detailed information which the OS does not define becomes available for printing.

After that, the drawing application 201 receives a print request from the user and then issues a print instruction to the OS. After the print instruction has been issued to the OS, the OS generates intermediate data including PT based on the print instruction output from the drawing application 201, and then passes the intermediate data to the print data generation software 202. The print data generation software 202 processes the intermediate data into print data which the printing apparatus 102 is able to interpret, and then passes the print data to the printing apparatus 102 via the OS.

The printing apparatus 102 extracts PT generated by the extension application 204 from the received print data and thus analyzes print setting attribute information. The printing apparatus 102 compares the analyzed print setting attribute information with attribute information indicating selectable functions (printing apparatus capabilities) stored in a database (not illustrated) included in the printing apparatus 102, and then determines setting values related to the attribute information.

The printing apparatus 102 forms drawing data on a paper surface based on the determined setting values, thus performing printing. Furthermore, the ink usage, which is information related to image processing, and the attracting suction force of a transport unit, which is information related to control, included in the attribute information are used to determine an image processing method and a print control method based on setting values set in the print setting attribute information.

### <Example of Screen for Displaying Paper Detailed Information by Print Setting Screen Extension Unit>

Next, a print setting screen available for displaying paper detailed information, which is displayed by the print setting screen extension unit 205, is described with reference to FIG. 6A and FIG. 6B.

PC (PrintCapabilities) is generated based on the print function information (PDC) 203 edited by the print function extension unit 207. In the first embodiment, a print setting screen 601 is displayed based on PC generated from the PDC 203 obtained by the print function extension unit 207 performing editing and updating as illustrated in FIGS. 3A and 3B. In the above-mentioned step S310 and step S320, pieces of paper detailed information have been added by the print function extension unit 207. This enables paper detailed information to be displayed to the user on a paper type setting screen 608 illustrated in FIG. 6B through the print setting screen 601 illustrated in FIG. 6A which the print setting screen extension unit 205 displays.

The print setting screen extension unit 205 is invoked and activated by the OS in a case where the user issues an instruction for displaying a print setting screen on the drawing application 201. The print setting screen extension unit 205 displays a screen available for the user to designate setting values of a print function which is able to be designated based on PC acquirable from the OS.

A control 602 illustrated in FIG. 6A is a control item which is usable to set the paper size for use in printing, and is thus usable to set an item such as A4 or Letter.

A control 603 is a control item which is usable to set the print orientation, and is thus usable to perform settings of portrait and landscape.

A display area 604 is an area which is usable to display the type of paper which is used for printing. A control 605 is a button which is usable to set the type of paper which is used for printing, and, in response to the control 605 being selected by the user, the paper type setting screen 608 illustrated in FIG. 6B (a screen in which paper type information and paper detailed information described below are displayed) is displayed. The control 605 is an example of a predetermined object.

A control 606 is a cancel button, and, in response to the control 606 being selected, the print setting screen 601 is closed with no settings being reflected.

A control 607 is an OK button, and, in response to the control 607 being selected, the print setting screen 601 is closed with settings being reflected. Moreover, in response to the control 607 being selected, in editing of paper detailed information described below, printing apparatus attribute data is reacquired from the printing apparatus 102. In a case where, as a result of comparison between the PDC 203 obtained before reacquisition and the PDC 203 obtained by reacquisition, there is no change, the print setting screen 601 is directly closed. In a case where there is a change, a message indicating that the paper detailed information has been updated is displayed.

In the first embodiment, it is assumed that A4 size has been selected as the paper size, portrait has been selected as the print orientation, and plain paler has been selected as the paper type.

In a case where the above-mentioned print function and another print function have been selected by the user and the control 607 serving as an OK button has been pressed, the print setting screen extension unit 205 reflects the selected print functions in PT (PrintTicket), and then ends the processing.

FIG. 6B illustrates the paper type setting screen 608, which is displayed in a case where the control 605 serving as a setting button has been pressed.

A control 609 is a button which is usable to reacquire paper information from the printing apparatus 102, and is thus usable to perform processing for adding paper detailed information to the print function information 203 described above with reference to FIGS. 3A and 3B and then update paper types displayed in a control 610 based on the updated PDC 203. The control 609 is an example of an object usable for acquiring paper detailed information from the printing apparatus 102.

The control 610 is a control item which is usable to select a paper type which is used for printing, and is thus usable to display paper detailed information for each paper type in list form. In the first embodiment, the name and class of paper shown in the control 610 are defined as paper type information. Moreover, information indicating properties of paper (grammage, characteristics, surface property, and color), information related to image processing which is performed in a printing apparatus (ink usage), and information related to control of a printing apparatus (the attracting suction force of a transport unit) are displayed in the control 610 in list form as paper detailed information. The paper detailed information is displayed in the control 610 in list form in association with paper type information for every paper type.

Moreover, the control 610 is used to display paper detailed information in list form for every paper and is also used to display the name of a source which has updated the paper detailed information last time and the date and time at which the paper detailed information has been updated last time.

Furthermore, items of the paper type information and paper detailed information are not limited to those mentioned in the first embodiment. Such items can include information other than the items mentioned in the first embodiment, and can be configured to include only some items of the items mentioned in the first embodiment.

Processing for displaying the paper type setting screen 608 and the control 610 is an example of a first display process.

A control 611 is a cancel button, and, in response to the control 611 being selected, the paper type setting screen 608 is closed with no settings being reflected.

A control 612 is an OK button, and, in response to the control 612 being selected, the paper type setting screen 608 is closed with settings being reflected.

For example, in the above-mentioned control 610, the user selects a paper type from within the paper type information and the paper detailed information and then presses the control 612 serving as an OK button. In this case, the print setting screen extension unit 205 reflects the selected paper type in the display area 604 illustrated in FIG. 6A (brings about a state in which the selected paper type has also been selected in the display area 604), and then returns the paper type setting screen 608 to the print setting screen 601 illustrated in FIG. 6A.

Furthermore, in the paper type setting screen 608, the user is able to select a desired paper type by selecting any one of the paper type information and the paper detailed information.

After selecting a desired paper type, the user is able to change, for example, settings of paper type and a display method in a paper information editing screen 617 (the details of which are described below) illustrated in FIG. 6C, which is displayed in response to a control 616 being selected by the user. For example, the content and a display method which have been changed in response to an instruction from the user in the paper information editing screen 617 are reflected in the paper type which is displayed in the display area 604 of the print setting screen 601 or the paper type information or the paper detailed information which is displayed in the control 610 of the paper type setting screen 608. Processing for displaying the display area 604 or the control 610 in which the change performed in response to an instruction from the user has been reflected is an example of a second display process.

### <Editing of Paper Information by Print Setting Screen Extension Unit>

Moreover, there is a possibility that, in settings of paper type, if the number of paper types is large, the user makes the wrong selection of a paper type. In light of this point, a configuration which receives, from the user, an instruction for changing the name of paper which is displayed in the control 610 of the paper type setting screen 608 illustrated in FIG. 6B and thus updates paper information retained in the printing apparatus 102 is described as an example. Additionally, since it may be time-consuming for the user to find a paper type which the user wants to use for printing from a large number of paper types, a configuration which receives an instruction for not displaying paper types which the user does not use for printing or deleting such paper types and then updates paper information retained in the printing apparatus 102 is described as an example.

The control 616 is a button available for editing paper information, and, in response to the user selecting a paper type in the control 610 and selecting the control 616, the paper information editing screen 617 illustrated in FIG. 6C is displayed. The control 616 is an example of an object available for receiving a change. Furthermore, in a case where the user is not selecting a paper type in the control 610, the control 616 is grayed out in such a way as to disable selection.

FIG. 6C illustrates the paper information editing screen 617, which is displayed in a case where the control 616 serving as a paper information editing button has been pressed. The paper information editing screen 617 is usable to receive a change regarding at least any one of the paper type information and the paper detailed information, and processing for receiving a change in the paper information editing screen 617 is an example of a reception process. Moreover, the paper information editing screen 617 is an example of a screen for receiving a change.

A control 618 is a control item for inputting a paper name, and is usable for changing a paper name. In response to the user inputting and setting a paper name to the control 618, a paper name which is displayed in the control 610 of the paper type setting screen 608 illustrated in FIG. 6B is changed to the paper name which has been input by the user.

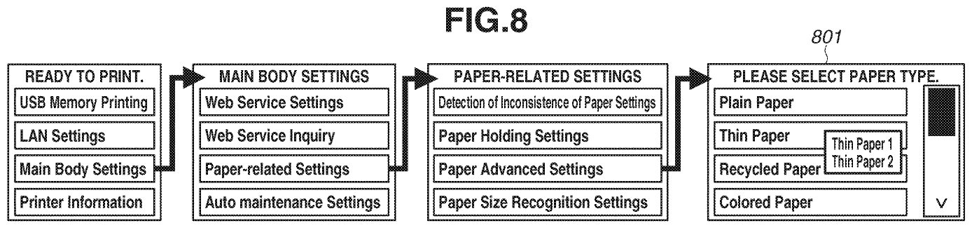

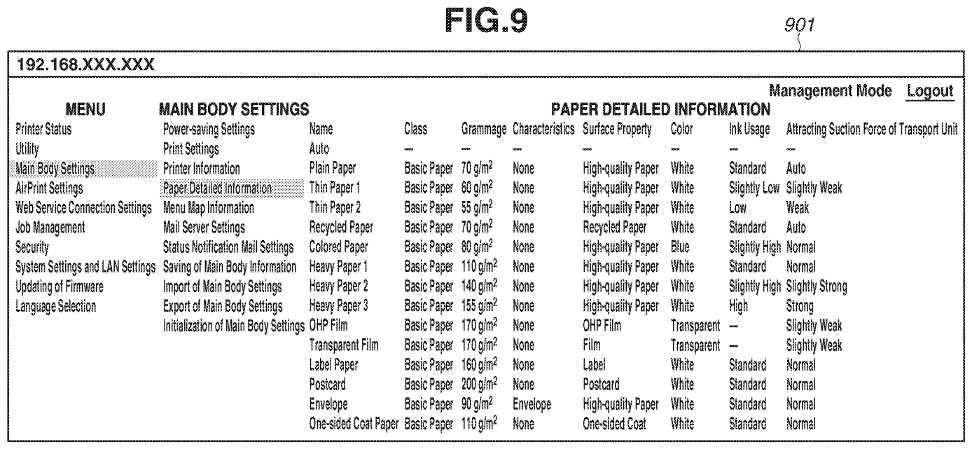

Moreover, a paper name which is displayed in an operation panel 801 (FIG. 8) described below and a web browser setting screen 901 (FIG. 9) described below of the printing apparatus 102 is also changed to the paper name which has been input by the user. The operation panel 801 of the printing apparatus 102 is an example of a display unit of the printing apparatus 102. The web browser setting screen 901 is an example of a remote user interface of the printing apparatus 102.

A control 619 is a control item available for selecting or changing whether to display paper, and is usable to change whether to select displaying or hiding (whether to display paper). In a case where hiding has been selected, the selected paper is grayed out from the paper types which are displayed in the control 610 of the paper type setting screen 608 illustrated in FIG. 6B. Moreover, the selected paper becomes not changed in the operation panel 801 and the web browser setting screen 901 of the printing apparatus 102.

A control 620 is a control item available for selecting or changing whether to delete a paper type selected by the user in the control 610 of the paper type setting screen 608 illustrated in FIG. 6B. In a case where deletion had been selected, the selected paper is deleted from the paper types which are displayed in the control 610 of the paper type setting screen 608 illustrated in FIG. 6B and then becomes not displayed.

Moreover, the selected paper is also deleted in the operation panel 801 and the web browser setting screen 901 of the printing apparatus 102 and then becomes not displayed. The control 620 is an example of a first object, and a process for displaying the control 620 is an example of a first display process.

A control 621 is a control item available for changing an ink usage for use in printing, and a control 622 is a control item available for changing the attracting suction force of a transport unit of the printing apparatus 102.

Furthermore, among the items of paper type information and paper detailed information which are displayed in list form in the control 610 of the paper type setting screen 608 illustrated in FIG. 6B, pieces of information indicating properties of paper (grammage, characteristics, surface property, and color) are items representing physical characteristics of paper and are, therefore, unable to be changed. Accordingly, the pieces of information indicating properties of paper do not exist as objects in the paper information editing screen 617 illustrated in FIG. 6C.

A control 623 is a cancel button, and, in response to the control 623 being selected, the paper information editing screen 617 is closed with no settings being reflected.

A control 624 is an OK button, and, in response to the control 624 being selected, the paper information editing screen 617 is closed with settings being reflected.

Furthermore, the items of paper information which are settable in the paper information editing screen 617 illustrated in FIG. 6C are not limited to those mentioned in the first embodiment. Such items can include information other than the items mentioned in the first embodiment, or can include only some items of the items mentioned in the first embodiment.

Moreover, an instruction for changing a display order is received from the user in such a way as to enable the user to promptly select a paper type which the user frequently uses, and paper information retained in the printing apparatus 102 is thus updated.

A control 614 illustrated in FIG. 6B is a control item available for moving a paper type selected by the user up one position in the display order in the control 610, so that the order of paper types which are displayed in the control 610 is switched. Similarly, a control 615 is a control item available for moving a paper type selected by the user down one position in the display order in the control 610.

Furthermore, in a case where the user is not selecting any paper type in the control 610, the controls 614 and 615 are grayed out in such a way as to be unavailable. Each of the controls 614 and 615 is an example of an object for changing the display order of paper type information and paper detailed information.

### <Updating of Attribute Information Retained in Printing Apparatus 102>

In a case where, in the paper information editing screen 617 illustrated in FIG. 6C, the control 624 serving as an OK button has been pressed so that the paper detailed information displayed in the control 610 of the paper type setting screen 608 illustrated in FIG. 6B has been changed, information concerning such a change is transmitted to the printing apparatus 102. Alternatively, in a case where, in the paper type setting screen 608 illustrated in FIG. 6B, the display order of paper types which are displayed has been changed by the control 614 or 615, information concerning such a change is transmitted to the printing apparatus 102 in response to a control 613 illustrated in FIG. 6B being selected.

The control 613 is a button (object) available for transmitting information concerning a change to the printing apparatus 102. In response to the user having selected the control 613, an instruction for changing paper detailed information is issued to the print function extension unit 207, and the content of the instruction is reflected in the PDC 203 and the capability information 401 illustrated in FIG. 4A. In addition, in response to an instruction from the print function extension unit 207, information concerning such a change is transmitted to the printing apparatus 102 based on a SetPrinterAttributes operation of the IPP which the OS or the print software issues.

Furthermore, in a case where the user has not pressed the control 613, the changed paper detailed information is transmitted to the printing apparatus 102 at timing when the control 612 serving as an OK button has been pressed.

However, attribute data which is able to be changed by a SetPrinterAttributes operation is only attribute information concerning paper information which the OS defines, and vendor-specific information which the OS is unable to interpret is not able to be changed. Thus, in a case where, in the paper information editing screen 617 illustrated in FIG. 6C, the ink usage in the control 621 and the attracting suction force of a transport unit in the control 622 have been changed, attribute data about the printing apparatus 102 is not able to be changed by a SetPrinterAttributes operation. This is because information concerning the ink usage and the attracting suction force of a transport unit is vendor-specifically defined information, which the OS is not able to interpret.

In this case, a PT (PrintTicket) which the OS issues in response to an instruction from the print software is used to change the attribute data about the printing apparatus 102. The print function extension unit 207, which has received a notification of change of paper detailed information from the print setting screen extension unit 205, instructs the OS or the print software to reflect the changed paper detailed information in the PT and then issue a dummy print instruction.

After the dummy print instruction has been issued, the OS or the print software generates intermediate data including a PT based on the dummy print instruction, which has been output from the OS or the print software in response to an instruction from the print function extension unit 207, and the intermediate data is passed to the print data generation software 202. The intermediate data is processed by the print data generation software 202 into dummy print data which the printing apparatus 102 is able to interpret, and the dummy print data is transmitted to the printing apparatus 102 via the OS and the print software. The dummy print data which is transmitted to the printing apparatus 102 at this time is an example of information concerning a change regarding at least any one of paper type information and paper detailed information.

The printing apparatus 102 extracts, from the received dummy print data, a PT generated by the extension application 204 and thus analyzes the attribute data. The printing apparatus 102 compares the analyzed attribute data with attribute data concerning paper stored in a database (not illustrated) included in the printing apparatus 102, and then updates, by overwriting, attribute information related to the attribute data and setting values related to the attribute information. Furthermore, since the print data which has been transmitted to the printing apparatus 102 is dummy, the printing apparatus 102 does not perform actual printing.

Furthermore, while, in the first embodiment, to edit paper detailed information, editing of paper types is performed in the paper information editing screen 617 illustrated in FIG. 6C, which is a screen different from the paper type setting screen 608 illustrated in FIG. 6B, a paper type can be selected in the paper type setting screen 608. When, in paper type information or paper detailed information which is displayed in the control 610, a paper type selected by the user has been right-clicked, a menu for changing, hiding, or deleting a paper name and moving up or down the display order is displayed as in a control 625 illustrated in FIG. 6D.

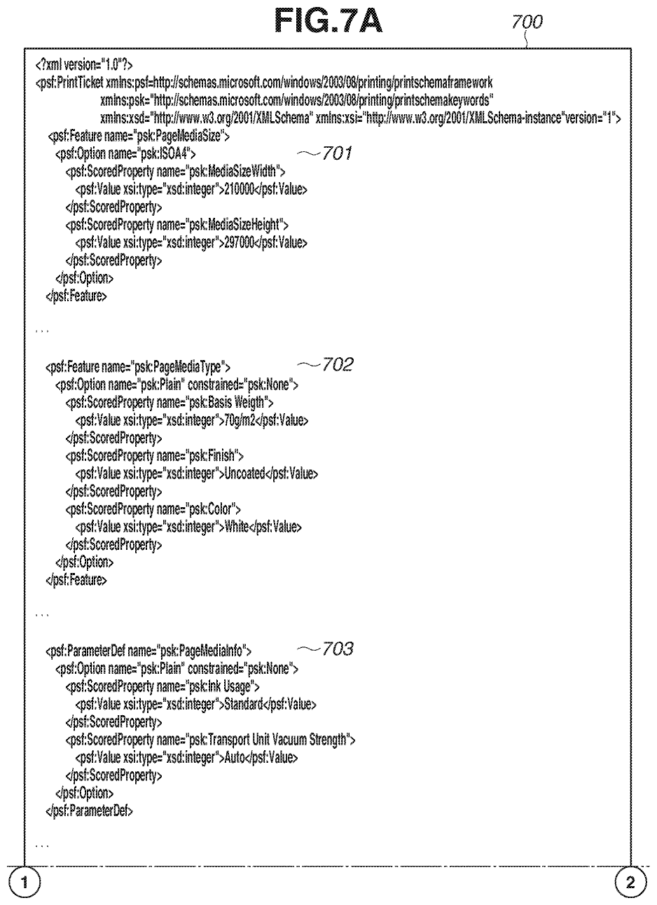

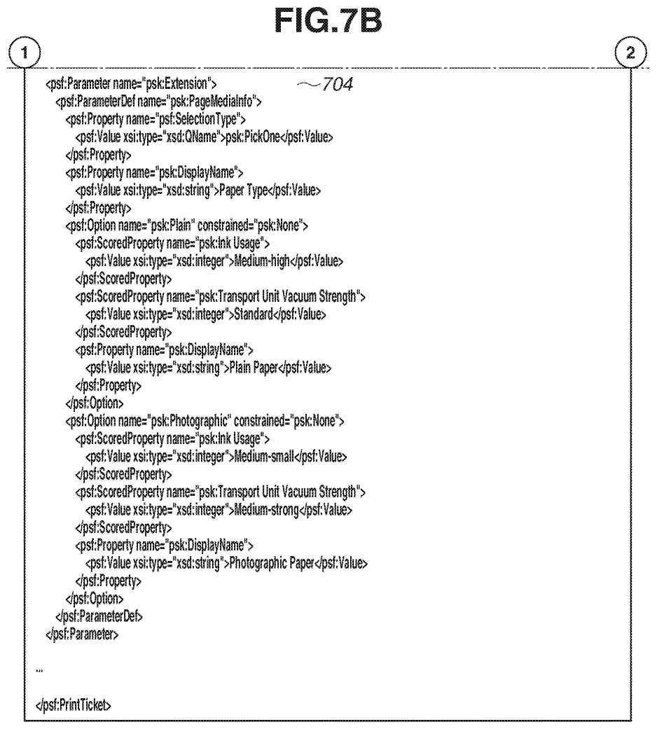

FIGS. 7A and 7B illustrate an example of a PT (PrintTicket) 700 which is in the state in which including the above-mentioned vendor-specific paper information which the OS does not define has been reflected by the print setting screen extension unit 205. Thus, Parameter “Extension” is provided, and the changed paper detailed information is written in the Parameter “Extension”.

Specifically, as shown in a function 704, attribute information concerning vendor-specific paper information which the OS does not define, as with the capability information 503 illustrated in FIGS. 5C1 and 5C2, is written in “Extension”. In this case, the changed paper detailed information is written in the parameter “ParameterDef”.

In a case where the ParameterDef name is PageMediaInfo and the Option name is Plain, “Medium-high” is written in Ink Usage and “Standard” is written in Transport Unit. In a case where the Option name is Photographic, “Medium-small” is written in Ink Usage and “Medium-strong” is written in Transport Unit.

Thus, the PT 700 indicates a PT updated to a selected state in which, with regard to pain paper, the ink usage is slightly high and the attracting suction force of a transport unit is standard and, with regard to photographic paper, the ink usage is slightly low and the attracting suction force of a transport unit is slightly strong.

A function 701 indicates a PT updated to a selected state in which the paper size is A4, and functions 702 and 703 indicate PTs updated to a selected state in which the paper type is plain paper and the detailed information about plain paper are respectively specified.

However, each of the functions 701 to 703 is print setting information related to a dummy print instruction and is, therefore, not checked by the printing apparatus 102.

In this way, in a case where the user has selected “slightly high” as the ink usage of plain paper and “standard” as the attracting suction force of a transport unit via the paper information editing screen 617, in response to an instruction from the print setting screen extension unit 205, the OS or the print software updates a PT. Similarly, in a case where the user has selected “slightly low” as the ink usage of photographic paper and “slightly strong” as the attracting suction force of a transport unit, in response to an instruction from the print setting screen extension unit 205, the OS or the print software updates a PT.

Furthermore, the ink usage or the attracting suction force of a transport unit which the user is able to change via the paper information editing screen 617 are not limited to the above-mentioned values. With regard to other paper types, the user is also able to select an optional item and make a change thereto. A PT which the OS or the print software has updated in response to an instruction from the print setting screen extension unit 205 is used hereafter.

Furthermore, the print setting screen extension unit 205 automatically determines which of a SetPrinterAttributes operation of the IPP and a PT to use in transmitting information concerning a change to the printing apparatus 102. Thus, in a case where the user has changed only attribute information concerning paper information which the OS defines, the paper detailed information changed with a SetPrinterAttributes operation is transmitted to the printing apparatus 102. In a case where the user has changed even one item of vendor-specific information which the OS does not define, the paper detailed information changed with a dummy print instruction using a PT is transmitted to the printing apparatus 102.

In the first embodiment, a configuration which automatically determines whether to issue a SetPrinterAttributes operation or issue a dummy print instruction, to transmit the changed paper detailed information to the printing apparatus 102, based on attribute information included in the changed paper detailed information has been described as an example. However, regardless of attribute information included in the changed paper detailed information, by issuing a dummy print instruction in every case, the changed paper detailed information can be transmitted to the printing apparatus 102.

Moreover, in a case where a SetPrinterAttributes operation has also become able to change vendor-specific information which the OS is unable to interpret, by issuing a SetPrinterAttributes operation in every case, the changed paper detailed information can be transmitted to the printing apparatus 102.

The printing apparatus 102 updates, by overwriting, paper detailed information retained in the printing apparatus 102, based on attribute data transmitted from the print data generation software 202 by a SetPrinterAttributes operation or a dummy print instruction. Specifically, the printing apparatus 102 updates, by overwriting, attribute information stored in a database (not illustrated) included in the printing apparatus 102 and setting values related to the attribute information. Moreover, the printing apparatus 102 records, on the database, the name of the host computer 101 serving as a transmission source and the date and time of updating.

FIG. 8 illustrates a transition example of menu screens each of which is displayed on an operation panel 801 of the printing apparatus 102. Moreover, FIG. 9 illustrates an example of paper information which is displayed in a web browser setting screen 901 of the printing apparatus 102. The operation panel 801 illustrated in FIG. 8 is able to display paper types by following menu screens successively displayed on the operation panel 801. Moreover, the web browser setting screen 901 illustrated in FIG. 9 is able to display a setting screen by designating an IP address set for the printing apparatus 102 with a web browser and is also able to display paper detailed information by following menu screens on the web browser setting screen 901.

When attribute information stored in a database (not illustrated) included in the printing apparatus 102 and setting values related to the attribute information have been saved by overwriting, paper information which is displayed on the operation panel 801 illustrated in FIG. 8 and paper information which is displayed on the web browser setting screen 901 illustrated in FIG. 9 are also updated.

After that, the print setting screen extension unit 205 instructs the print function extension unit 207 to reacquire printing apparatus attribute data from the printing apparatus 102 at timing when the control 607 serving as an OK button has been pressed in the print setting screen 601 illustrated in FIG. 6A. The print function extension unit 207 reacquires printing apparatus attribute data from the printing apparatus 102 via the print data generation software 202 or the OS, and then regenerates the PDC 203 according to attribute information included in the reacquired attribute data.

The print setting screen extension unit 205 compares the PDC 203 obtained before regeneration with the PDC 203 obtained by regeneration and thus checks whether the paper detailed information changed by the user has been reflected in the PDC 203.

In a case where the change has been reflected, i.e., in a case where the PDC 203 obtained before regeneration and the PDC 203 obtained by regeneration coincide with each other, the print setting screen 601 is directly closed.

In a case where the PDC 203 obtained before regeneration and the PDC 203 obtained by regeneration do not coincide with each other, a message indicating that the paper detailed information has been updated is displayed. Furthermore, the case where the PDC 203 obtained before regeneration and the PDC 203 obtained by regeneration do not coincide with each other can be considered as a case where the change has not been reflected due to a malfunction in the printing apparatus 102. Alternatively, a case where the paper detailed information has been changed by another information processing apparatus at the same timing and attribute information indicating the capability of the printing apparatus 102 and setting values related to the attribute information have been updated by overwriting can also be considered.

Thus far is the description of an example of enabling the print function extension unit 207 of the extension application 204 to edit paper detailed information. According to the method described in the first embodiment, it becomes possible to display paper type information and paper detailed information in list form in the print setting screen of the extension application 204 and then edit the paper type information and paper detailed information displayed in list form. This enables the user to check, for example, the paper name and the display method which have been set for each paper type and then perform an operation on the printing apparatus 102 to change paper information retained in the printing apparatus 102.

Moreover, further displaying the ink usage and the attracting suction force of a transport unit for each paper type also enables the user to, while paying attention to, for example, an ink consumption of the printing apparatus 102 and a burden on a transport unit, perform an operation on the printing apparatus 102 to change paper information retained in the printing apparatus 102.

### Second Embodiment

The present disclosure is not limited to the above-described embodiment. In the first embodiment described above, in the case of changing vendor-specific information which the OS does not define in the paper information editing screen 617 illustrated in FIG. 6C, a PT (PrintTicket) is used to change attribute data about the printing apparatus 102. On this occasion, the print function extension unit 207 causes the OS to issue a dummy print instruction and the print data generation software 202 generates dummy print data and transmits the dummy print data to the printing apparatus 102.

The printing apparatus 102 extracts a PT from the received dummy print data and then updates, by overwriting, attribute information included in attribute data related to paper stored in a database (not illustrated) included in the printing apparatus 102 and setting values related to the attribute information. However, since the print data which has been transmitted to the printing apparatus 102 is dummy, actual printing is not performed.

However, there is considered a case where only vendor-specific information which the OS is unable to interpret has been changed in the paper information editing screen 617 illustrated in FIG. 6C. In this case, at timing when the user has actually issued a print instruction to the drawing application 201, information concerning a change can be transmitted to the printing apparatus 102 together with print data. Thus, concurrently with printing performed by the printing apparatus 102, attribute data concerning paper for use in the printing apparatus 102 can be updated.

Furthermore, constituent elements of the system which are not particularly mentioned in the description of a second embodiment described below are similar to those in the first embodiment and are, therefore, omitted from description here. Moreover, processing operations of the flow which are not particularly mentioned in the description of the second embodiment are similar to those in the first embodiment and are, therefore, omitted from description here.

After, in the paper information editing screen 617 illustrated in FIG. 6C, the user has changed vendor-specific information which the OS does not define, the paper information editing screen 617 returns to the print setting screen 601 illustrated in FIG. 6A.

Next, in the print setting screen 601 illustrated in FIG. 6A, a print function and other print functions are selected by the user, and the print setting screen extension unit 205 reflects the selected print functions in a PT (PrintTicket).

On this occasion, in the PT, as described above with reference to the PT 700 illustrated in FIGS. 7A and 7B, the paper detailed information which has been changed by the user in the paper information editing screen 617 illustrated in FIG. 6C (vendor-specific information which the OS does not define) is written in Parameter “Extension” of the function 704.

On the other hand, the print function and other print functions which have been selected by the user in the print setting screen 601 illustrated in FIG. 6A are written as explained above with reference to the function 701, function 702, and function 703 illustrated in FIGS. 7A and 7B. Furthermore, the user does not necessarily need to select the paper detailed information which has been changed by the user in the paper information editing screen 617 illustrated in FIG. 6C as a print function and other print functions.

After that, the drawing application 201 receives a print request from the user, and a print instruction is issued to the OS. After the print instruction is issued to the OS, the OS generates intermediate data including a PT based on the print instruction output from the drawing application 201, and the intermediate data is passed to the print data generation software 202. The intermediate data is processed by the print data generation software 202 into print data which the printing apparatus 102 is able to interpret, and the print data is passed to the printing apparatus 102 via the OS.

The printing apparatus 102 extracts, from the received print data, a PT generated by the extension application 204, and thus analyzes attribute data written in the function 704 and pieces of print setting attribute information written in the function 701, function 702, and function 703.

The printing apparatus 102 compares the analyzed attribute data with attribute data concerning paper stored in a database (not illustrated) included in the printing apparatus 102, and then updates, by overwriting, attribute information related to the attribute data and setting values related to the attribute information. Additionally, the printing apparatus 102 compares the analyzed pieces of print setting attribute information with attribute information indicating configurable functions (printing apparatus capabilities) stored in a database (not illustrated) included in the printing apparatus 102, and thus determines setting values related to the attribute information. The printing apparatus 102 forms drawing data on a paper surface based on the determined setting values, thus performing printing.

Furthermore, there is also a case where, immediately after changing paper detailed information in the paper information editing screen 617 illustrated in FIG. 6C, the user does not issue an actual print request to the drawing application 201, i.e., does not instruct the printing apparatus 102 to perform printing. In this case, a configuration which reflects, in a PT, a print function and other print functions which have been selected by the user at timing when the user instructs the printing apparatus 102 next to perform printing can be employed.

According to the method described in the second embodiment, it is possible to concurrently perform, with respect to the printing apparatus 102, printing which is performed by the printing apparatus 102 and changing of paper information which is retained in the printing apparatus 102. This saves the user's trouble of separately performing printing and changing of paper information. Moreover, as compared with the case of separately performing printing and changing of paper information, it is possible to reduce the amount of data transmitted and received between the host computer 101 and the printing apparatus 102.

### Third Embodiment

In the above-described first embodiment, the print setting screen extension unit 205 transmits information concerning a change received in the paper information editing screen 617 illustrated in FIG. 6C to the printing apparatus 102 with use of a SetPrinterAttributes operation or a PT (PrintTicket).

The print setting screen extension unit 205 can perform such transmission via, instead of the above-mentioned transmission method, a vendor-specific communication protocol. In this case, a module which processes the vendor-specific communication protocol is preliminarily stored in an installation package for the extension application 204.

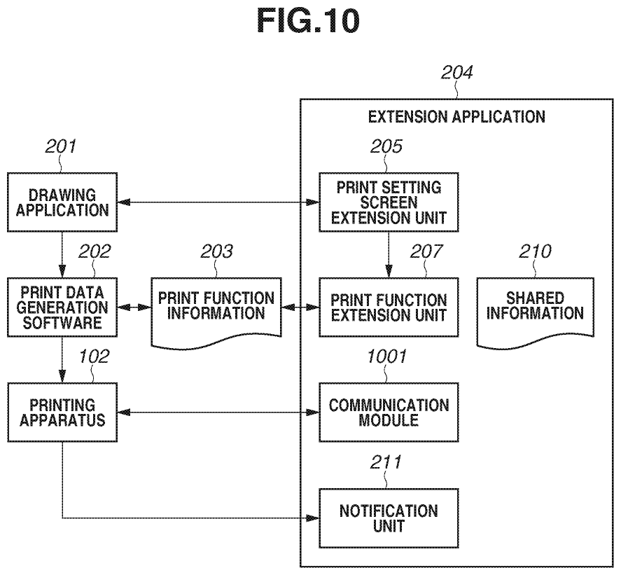

FIG. 10 is a diagram schematically illustrating a configuration of a printing system centering on software according to a third embodiment. The configuration illustrated in FIG. 10 differs from the configuration illustrated in FIG. 2B in the first embodiment in that a communication module 1001 which processes a vendor-specific communication protocol is added to the extension application 204.

In a case where paper detailed information has been changed by the user in the paper information editing screen 617 illustrated in FIG. 6C, the print setting screen extension unit 205 notifies the print function extension unit 207 of the extension application 204 of the changed paper detailed information. The print function extension unit 207, which has received such notification, reflects the changed paper detailed information in the PDC 203, and further reflects setting values of attribute information corresponding to the changed paper detailed information in the capability information 401 illustrated in FIG. 4A. At the same time, the extension application 204 invokes the communication module 1001 and thus causes the communication module 1001 to transmit the changed paper detailed information to the printing apparatus 102.

The printing apparatus 102 updates, by overwriting, attribute information indicating the capability of the printing apparatus 102 and setting values related to the attribute information based on the attribute data transmitted from the communication module 1001 of the extension application 204.

The other constituent elements and processing operations are similar to those illustrated in FIG. 2B.

According to the method described in the third embodiment, it is possible to change, with respect to the printing apparatus 102, paper information retained in the printing apparatus 102 at optional timing without being constrained by the OS or the print data generation software 202. Moreover, in a case where new attribute information has been additionally defined in vendor-specific paper detailed information which the OS does not define, it is also possible to support such a case by updating firmware of the printing apparatus 102 and a module which processes a vendor-specific communication protocol.

The present disclosure can also be implemented by processing for supplying a program for implementing one or more functions of the above-described embodiments to a system or apparatus via a network or a storage medium and causing one or more processors in a computer of the system or apparatus to read out and execute the program. Moreover, the present disclosure can also be implemented by a circuit which implements one or more functions of the above-described embodiments (for example, an application specific integrated circuit (ASIC)).

According to an aspect of the present disclosure, it is possible to increase the user's convenience in the case of using an application which supports a standard driver.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-080629 filed May 13, 2025, which is hereby incorporated by reference herein in its entirety.

What is claimed is:

1. A non-transitory computer-readable storage medium storing an application program which causes an information processing apparatus, which is connected to a printing apparatus, to perform a control method, the application program cooperating with a standard driver which is provided by a provider of an operating system of the information processing apparatus, the control method comprising:
acquiring paper detailed information including at least information indicating properties of paper which is used in the printing apparatus;
receiving a change regarding at least one of paper type information, which is information indicating a type of the paper, and the paper detailed information; and
transmitting information concerning the change to the printing apparatus.

2. The non-transitory computer-readable storage medium according to claim 1, wherein the paper detailed information further includes at least any one of information related to image processing which is performed in the printing apparatus and information related to control of the printing apparatus.

3. The non-transitory computer-readable storage medium according to claim 2, wherein the information indicating properties of paper includes at least any one of information indicating a grammage of the paper, information indicating characteristics of the paper, information indicating a surface property of the paper, and information indicating a color of the paper, the information related to image processing which is performed in the printing apparatus is information indicating an ink usage in performing printing on the paper, and the information related to control of the printing apparatus is information indicating an attracting suction force of a transport unit of the printing apparatus in performing printing on the paper.

4. The non-transitory computer-readable storage medium according to claim 1, wherein the paper detailed information includes at least any one of information which the operating system of the information processing apparatus is able to interpret and information which the operating system is unable to interpret.

5. The non-transitory computer-readable storage medium according to claim 2, wherein, when the application program is installed on the information processing apparatus, at least any one of the information related to image processing which is performed in the printing apparatus and the information related to control of the printing apparatus is stored in the information processing apparatus together with the application program.

6. The non-transitory computer-readable storage medium according to claim 1, wherein the paper detailed information is acquired from an external apparatus different from the printing apparatus.

7. The non-transitory computer-readable storage medium according to claim 1, wherein the control method further comprises:
displaying a print setting screen and, in response to a user selecting a predetermined object displayed on the print setting screen, displaying the paper type information and the paper detailed information.

8. The non-transitory computer-readable storage medium according to claim 1, wherein the control method further comprises:
performing a first display process for displaying the paper type information and the paper detailed information;
in the first display process, displaying, together with the paper type information and the paper detailed information, an object for receiving the change; and
in response to a user selecting the object for receiving the change, displaying a screen available for receiving the change.

9. The non-transitory computer-readable storage medium according to claim 8, wherein the control method further comprises:
in the first display process, displaying, together with the paper type information and the paper detailed information, an object for transmitting the information concerning the change; and
in response to the user selecting the object for transmitting the information concerning the change, transmitting the information concerning the change to the printing apparatus.

10. The non-transitory computer-readable storage medium according to claim 8, wherein the control method further comprises:
in the first display process, displaying, together with the paper type information and the paper detailed information, an object for acquiring the paper detailed information from the printing apparatus.

11. The non-transitory computer-readable storage medium according to claim 8, wherein the control method further comprises:
in the first display process, displaying, together with the paper type information and the paper detailed information, an object for changing a display order of the paper type information and the paper detailed information.

12. The non-transitory computer-readable storage medium according to claim 8, wherein the control method further comprises:
in the first display process, displaying the object for receiving the change under an unselectable state; and
in response to the user selecting a paper type from the paper type information and the paper detailed information, displaying the object for receiving the change under a selectable state.

13. The non-transitory computer-readable storage medium according to claim 1, wherein the control method further comprises:
performing a second display process for displaying the paper type information and the paper detailed information corresponding to the received change.

14. The non-transitory computer-readable storage medium according to claim 1, wherein the control method further comprises:
transmitting the paper detailed information to the printing apparatus in compliance with Internet Printing Protocol.

15. The non-transitory computer-readable storage medium according to claim 1, wherein the control method further comprises:
transmitting the paper detailed information to the printing apparatus with use of SetPrinterAttributes which the operating system of the information processing apparatus issues.

16. The non-transitory computer-readable storage medium according to claim 1, wherein the control method further comprises:
transmitting the paper detailed information to the printing apparatus with use of PrintTicket which the operating system of the information processing apparatus issues.

17. The non-transitory computer-readable storage medium according to claim 1, wherein the control method further comprises:
in response to a user issuing a print instruction, transmitting, together with print data, the information concerning the change to the printing apparatus.

18. The non-transitory computer-readable storage medium according to claim 1, wherein the control method further comprises:
displaying the paper detailed information corresponding to the information concerning the change on a display unit of the printing apparatus.

19. A control method for an information processing apparatus, which is connected to a printing apparatus and on which a standard driver and an application program are installed, the application program cooperating with the standard driver which is provided by a provider of an operating system of the information processing apparatus, the control method comprising:
acquiring paper detailed information including at least information indicating properties of paper which is used in the printing apparatus;
receiving a change regarding at least one of paper type information, which is information indicating a type of the paper, and the paper detailed information; and
transmitting information concerning the change to the printing apparatus.

20. An information processing apparatus, which is connected to a printing apparatus and on which a standard driver and an application program are installed, the application program cooperating with the standard driver which is provided by a provider of an operating system of the information processing apparatus, the information processing apparatus comprising:
at least one memory storing instructions; and
at least one processor that executes the stored instructions, which causes the application program to:
acquire paper detailed information including at least information indicating properties of paper which is used in the printing apparatus;
receive a change regarding at least one of paper type information, which is information indicating a type of the paper, and the paper detailed information; and
transmit information concerning the change to the printing apparatus.
